(19) United States
(12) Patent Application Publication
(10) Pub. No.: US 2026/0145341 A1
(43) Pub. Date: May 28, 2026

(54) TACTILE COMPONENT, BIONIC STRUCTURE AND PERCEPTUAL FEEDBACK METHOD THEREOF

(71) Applicant: Mind with Heart Robotics Co., Ltd., Shenzhen (CN)

(72) Inventors: Gong Chen, Shenzhen (CN); Qibiao Yu, Shenzhen (CN); Qiqing Chen, Shenzhen (CN); Jiaming Zhang, Shenzhen (CN)

(21) Appl. No.: 19/008,624

(22) Filed: Jan. 2, 2025

(30) Foreign Application Priority Data
Nov. 27, 2024 (CN) 202411708853.0

(51) Int. Cl. B25J 13/08; B25J 11/00; G01D 5/24

(52) U.S. Cl. CPC B25J 13/084; B25J 11/0005; G01D 5/24

(57) ABSTRACT

The disclosure discloses a tactile component, a bionic structure and a perceptual feedback method thereof. The tactile component includes an induction sheet, a sensor and a controller, wherein the induction sheet is arranged on a touched object and used to collect a touch induction signal; the induction sheet can be bent or flattened when stressed; the sensor is arranged on the touched object and used to collect an attitude signal of the touched object and an acceleration signal of the touch object; and the controller is connected to the induction sheet and the sensor and used to generate touch induction information, attitude information and acceleration information according to the received touch induction signal, attitude signal and acceleration signal. According to the disclosure, the problem that the traditional touch sensor is difficult to be installed at a curved-surface part is solved, and the appearance simulation of a bionic body is promoted.

### CROSS REFERENCES TO RELATED APPLICATION

The present application claims the benefit of Chinese Patent Application No. 202411708853.0 filed on Nov. 27, 2024, the contents of which are incorporated herein by reference in their entirety.

### TECHNICAL FIELD

The disclosure relates to the field of bionic technologies, and more particularly, to a tactile component, a bionic structure and a perceptual feedback method thereof.

### BACKGROUND ART

In order to allow a bionic robot to perceive external environmental changes and provide information feedback, a touch sensor is generally installed on the outer surface of the bionic robot. However, this setting not only hinders the implementation of a realistic bionic appearance, but also makes some parts of the bionic robot curved, which is not convenient for the installation of the touch sensor. In addition, the touch sensor only uses the content of the touch itself as an output, which is not conducive to subsequent analysis and thus cannot achieve friendly interactions with the bionic robot.

### SUMMARY OF THE INVENTION

An objective of the disclosure is to overcome the deficiencies of the prior art and provide a tactile component, a bionic structure and a perceptual feedback method thereof, which aim to solve the problem that a touch sensor cannot be installed on a curved-surface part of a bionic robot and is prone to hindering a bionic appearance.

In order to fulfill the above objectives, the technical solutions of the disclosure are summarized as follows.

In a first aspect, the disclosure provides a tactile component. The tactile component includes:
an induction sheet, which is arranged on a touched object and used to collect a touch induction signal while being in direct or indirect contact with a touch object;
a sensor, which is arranged on the touched object and used to collect an attitude signal of the touched object and an acceleration signal of the touch object during the direct or indirect contact of the induction sheet with the touch object; and
a controller, which is connected to the induction sheet and the sensor and used to generate touch induction information, attitude information and acceleration information according to the received touch induction signal, attitude signal and acceleration signal, wherein
the induction sheet can be bent or flattened when stressed.

Further, the induction sheet is provided with at least one touch induction electrode which is used to generate the touch induction signal while being in direct or indirect contact with the touch object.

Further, the induction sheet includes a substrate and a conductor; the conductor and the touch induction electrode are both arranged on the substrate; the conductor is connected to the touch induction electrode; and the substrate is made of a flexible and bendable material.

Further, the touch induction electrode is a capacitive electrode or a pressure electrode.

Further, the induction sheet is provided with a plurality of holes and/or openings.

In a second aspect, the disclosure further provides a bionic structure. The bionic structure includes a bionic body and the above-mentioned tactile component, wherein the touched object is the bionic body; the tactile component is arranged on the bionic body; the bionic body includes a profiling skeleton and a covering layer; the covering layer is arranged on the surface of the profiling skeleton; and the induction sheet is arranged between the profiling skeleton and the covering layer.

Further, the bionic body is in a human-like shape, an animal-like shape or an organ-like shape.

Further, the bionic body is respectively provided with the tactile component at different parts and further includes a master controller; and the tactile components corresponding to different parts of the bionic body are electrically connected to the same master controller.

In a third aspect, the disclosure further provides a perceptual feedback method of a bionic structure. The perceptual feedback method includes:
acquiring touch induction information, attitude information and acceleration information collected by tactile components at respective parts of a touched object when a touch object is in contact with the touched object;
performing comprehensive analysis on the touch induction information, attitude information, acceleration information and interaction information collected by the tactile components at the respective parts to obtain emotional information of the touch object; and
generating feedback information by the touched object according to the emotional information of the touch object, the feedback information including sounds, action behaviors, and facial expressions.

In a fourth aspect, the disclosure further provides a perceptual feedback method of a bionic structure. The perceptual feedback method includes:
acquiring touch induction information, attitude information and acceleration information collected by tactile components at respective parts of a touched object when a touch object is in contact with the touched object, and acquiring speech or text interaction information between the touch object and the touched object;
performing comprehensive analysis on the touch induction information, attitude information, acceleration information and interaction information collected by the tactile components at the respective parts to obtain emotional information of the touch object; and
generating feedback information by the touched object according to the emotional information of the touch object, the feedback information including sounds, action behaviors, and facial expressions.

Compared with the prior art, the disclosure has the following beneficial effects: a tactile component includes an induction sheet, a sensor and a controller, wherein the induction sheet is arranged on a touched object and collects a touch induction signal while being in direct or indirect contact with a touch object; the induction sheet can be bent or flattened when stressed; the sensor is arranged on the touched object and collects an attitude signal of the touched object and an acceleration signal of the touch object during the direct or indirect contact of the induction sheet with the touch object; and the controller is connected to the induction sheet and the sensor and generates touch induction information, attitude information and acceleration information according to the received touch induction signal, attitude signal and acceleration signal. The induction sheet of the disclosure can be bent or flattened when stressed and can thus be conveniently installed at various curved-surface parts of the bionic body such as a human-like robot or animal-like robot, rather than being installed on the surface of the bionic body, thereby solving the problem that the traditional touch sensor is difficult to be installed on the curved-surface part, and improving the appearance simulation of the bionic body. Meanwhile, the tactile component can not only collect the touch induction signal, but also acquire the attitude signal and the acceleration signal at the same time, which is conducive to subsequent analysis. In addition, the tactile component may be used as an independent module which is deployed in the respective parts of the bionic body, which is conducive to comprehensive signal collection of the bionic body.

The above description is only an overview of the technical solutions of the disclosure, and may be implemented in accordance with the content of the description in order to be able to understand the technical means of the disclosure more clearly. In addition, in order to make the above and other objects, features and advantages of the disclosure more obvious and easy to understand, the following preferred embodiments of the disclosure are illustrated below.

### BRIEF DESCRIPTION OF THE DRAWINGS

To describe the technical solutions in the embodiments of the disclosure more clearly, the following briefly introduces the accompanying drawings required for describing the embodiments. Apparently, the accompanying drawings in the following description show merely some embodiments of the disclosure, and a person of ordinary skill in the art may still derive other drawings from these accompanying drawings without paying creative efforts, in which:

FIG. 1 is a schematic structural diagram of a tactile component provided by a specific embodiment of the disclosure;

FIG. 2 is a schematic structural diagram of an induction sheet in a tactile component provided by a specific embodiment of the disclosure;

FIG. 3 is a schematic diagram of the installation of a tactile component provided by a specific embodiment of the disclosure;

FIG. 4 is a working principle diagram of a bionic structure provided by a specific embodiment of the disclosure;

FIG. 5 is a schematic structural diagram of an appearance of a bionic structure in a human-like shape provided by a specific embodiment of the disclosure;

FIG. 6 is a schematic structural diagram of a bionic structure in a human-like shape provided by a specific embodiment of the disclosure (a covering layer is removed);

FIG. 7 is a schematic structural diagram of an induction sheet and an induction plate in a bionic structure in a human-like shape provided by a specific embodiment of the disclosure;

FIG. 8 is a schematic structural diagram of an induction sheet and an induction plate in a bionic structure in a human-like shape, which are installed on a profiling skeleton, provided by a specific embodiment of the disclosure;

FIG. 9 is a schematic structural diagram of an induction sheet in a bionic structure in a human-like shape, which is installed on a profiling skeleton, provided by a specific embodiment of the disclosure;

FIG. 10 is a schematic diagram of a shape of an induction sheet at an abdomen position in a bionic structure in a human-like shape provided by a specific embodiment of the disclosure;

FIG. 11 is a schematic structural diagram of an appearance of a bionic structure in an animal-like shape provided by a specific embodiment of the disclosure;

FIG. 12 is a schematic structural diagram of a bionic structure in an animal-like shape provided by a specific embodiment of the disclosure (a covering layer is removed);

FIG. 13 is a schematic structural diagram of an induction sheet and an induction plate in a bionic structure in an animal-like shape provided by a specific embodiment of the disclosure;

FIG. 14 is a schematic structural diagram of an induction sheet in a bionic structure in an animal-like shape, which is installed on a profiling skeleton, provided by a specific embodiment of the disclosure;

FIG. 15 is a schematic structural diagram of an induction sheet and an induction plate in a bionic structure in an animal-like shape, which are installed on a profiling skeleton, provided by a specific embodiment of the disclosure;

FIG. 16 is a schematic diagram of a shape of an induction sheet at a head-top position in a bionic structure in an animal-like shape provided by a specific embodiment of the disclosure;

FIG. 17 is a schematic sectional view of a bionic structure in an organ-like shape provided by a specific embodiment of the disclosure; and

FIG. 18 is an exploded view of a bionic structure in an organ-like shape provided by a specific embodiment of the disclosure.

### REFERENCE NUMERALS

1—tactile component; 11—induction sheet; 111—touch induction electrode; 112—hole; 113—opening; 12—sensor; 13—controller; 14—induction plate; 2—bionic body; 21—covering layer; 22—profiling skeleton; and 3—master controller.

### DETAILED DESCRIPTION OF THE INVENTION

The technical solutions of the disclosure will be described clearly and completely in conjunction with the specific embodiments of the disclosure. Apparently, the described embodiments are merely some embodiments, rather than all embodiments, of the disclosure. Based on the embodiments of the disclosure, all other examples derived by a person of ordinary skill in the art without creative efforts shall fall within the protection scope of the disclosure.

In the description of the disclosure, it should be understood that the orientation or position relations indicated via terms of “central”, “longitudinal”, “transverse”, “length”, “width”, “thickness”, “upper”, “lower”, “front”, “rear”, “left”, “right”, “vertical” “horizontal”, “top”, “bottom”, “inner”, “outer”, “clockwise”, “counterclockwise”, “axial”, “radial”, “circumferential” and the like are based on orientation or the position relations shown in the drawings only to describe the disclosure conveniently and simplify the description, but not indicate or imply that referred devices or elements must have particular orientations or be constructed and operated with the particular orientation, so that they cannot be construed as limiting of the disclosure.

Moreover, the terms “first” and “second” are only for the purpose of description and should not be construed as indicating or implying relative importance or implicitly indicating the number of technical features indicated. Thus, the features defined by the terms “first” and “second” may include one or more of the features either explicitly or implicitly. In the descriptions of the disclosure, unless otherwise specifically limited, the term “plurality” means at least two, such as two, three, etc.

In the disclosure, unless otherwise definitely specified and limited, the terms “mounted”, “connected with each other”, “connected to/with”, “fixed” and the like need to be broadly understood, for example, connection may be fixed connection, or detachable connection or integrated connection; or may be mechanical connection, or electrical connection; or may be direct connection, or indirect connection via an intermediation, or communication of inner parts of two elements, or an interaction relationship between two elements. Those skilled in the art can understand the specific meaning of the above terms in the disclosure in accordance with specific conditions.

In the disclosure, unless otherwise definitely specified and limited, the first feature being provided “above” or “below” the second feature may mean that the first feature is in direct contact with the second feature, or indirectly in contact with the second feature via an intermediation. Moreover, the first feature being provided “over”, “above”, and “on” the second feature may mean that the first feature is provided directly above or diagonally above the second feature, or merely means that a level of the first feature is higher than the second feature. The first feature being provided “under”, “below”, and “beneath” the second feature may mean that the first feature is provided directly below or diagonally below the second feature, or merely means that a level of the first feature is lower than the second feature.

It should be noted that when an element is referred to as being “fixed to” or “arranged on” another element, it may be directly located on the other element, or an intermediate element may also exist. When an element is referred to as being “connected to” another element, it may be directly connected to the other element, or an intermediate element exists at the same time. The terms “vertical”, “horizontal”, “upper”, “lower”, “left”, “right” and similar expressions used herein are for the purpose of illustration, but are not intended to be the sole embodiment.

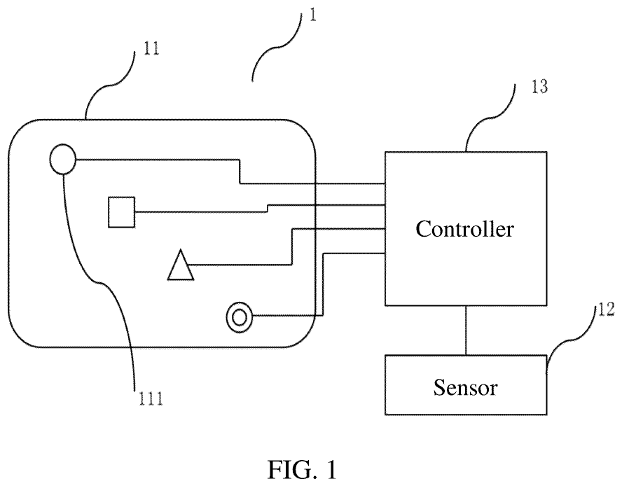

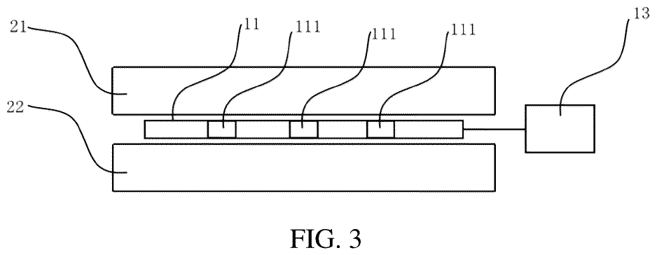

As shown in FIG. 1 to FIG. 4, an embodiment of the disclosure provides a tactile component 1. The tactile component includes an induction sheet 11, a sensor 12 and a controller 13. The induction sheet 11 is arranged on a touched object and collects a touch induction signal while being in direct or indirect contact with a touch object. The induction sheet 11 can be bent or flattened when stressed. The sensor 12 is arranged on the touched object and collects an attitude signal of the touched object and an acceleration signal of the touch object during the direct or indirect contact of the induction sheet 11 with the touch object. The controller 13 is connected to the induction sheet 11 and the sensor 12 and generates touch induction information, attitude information and acceleration information according to the received touch induction signal, attitude signal and acceleration signal.

The touch object may be a person or an animal, and the touched object may be a robot in a human-like shape or a robot in an animal-like shape.

The induction sheet 11 can be bent or flattened when stressed and can thus be conveniently installed at various curved-surface parts of the bionic body 2 such as a human-like robot or animal-like robot, rather than being installed on the surface of the bionic body 2, thereby solving the problem that the traditional touch sensor 12 is difficult to be installed on the curved-surface part, and improving the appearance simulation of the bionic body 2. Meanwhile, the tactile component 1 can not only acquire the touch induction signal, but also acquire the attitude signal and the acceleration signal at the same time, which is conducive to subsequent analysis. In addition, the tactile component 1 may be used as an independent module which is deployed at respective parts of the bionic body 2, which is conducive to comprehensive signal collection of the bionic body 2.

The sensor 12 and the controller 13 can be designed separately, or can be designed integrally. In the case of integrated design, a substrate is provided on which the controller 13 and the sensor 12 are integrally designed to form an induction plate 14. The induction plate 14 may be flexible or rigid. Such design is convenient for the installation of the tactile component 1.

In the present application, the sensor 12 may refer to a single sensor or may be a combination of multiple types of sensors. When only one type of sensor is used, this sensor must have at least the ability to acquire the attitude signal of the touched object and the acceleration signal of the touch object. For example, gyroscope sensors, which are commonly found on the market, can provide attitude information by measuring angular velocities, while often integrated with accelerometers to capture movement accelerations of objects. When multiple types of sensors are used, they may be a combination of an acceleration sensor and an attitude sensor, wherein the acceleration sensor is used to acquire the acceleration signal of the touch object, and the attitude sensor is used to collect the attitude signal of the touched object.

In the present application, the controller 13 should at least have the abilities to process the touch induction signal from the induction sheet 11 and the attitude and acceleration signals from the sensor 12, and to analyze and process the received touch induction signal, attitude signal and acceleration signal to generate and output touch induction information, attitude information and acceleration information. The controller 13 with these abilities may be a controller 13 of STM32, BeagleBone series, Arduino series, or Raspberry Pi series on the market.

In the present application, the touch induction information includes a touch position, a touch posture of the touch object (e.g., a touch gesture when a person touches with his/her hands), and a touch force. The attitude information includes a current attitude of the touch object and an attitude change process of the touch object. The acceleration information includes a magnitude of velocity change and a velocity direction.

In one embodiment, the induction sheet 11 is provided with at least one touch induction electrode 111 which generates a touch induction signal while being in direct or indirect contact with the touch object.

It should be noted that the touch induction electrode 111 may be in direct or indirect contact with the touch object, wherein the direct contact is applicable to a scene where the surface of the touch induction electrode 111 is not covered with additional material. In the case of indirect contact, the outer surface of the touch induction electrode 111 is covered with additional material, but the additional material does not affect the normal operation of the touch induction electrode 111. That is, the touch induction electrode 111 can still form inductive contact across this layer of material.

In one embodiment, the induction sheet 11 may be a plane or a curved surface of any shape. The induction sheet 11 includes a substrate and a conductor. The conductor and the touch induction electrode 111 are both arranged on the substrate. The conductor is connected to the touch induction electrode 111. The substrate is made of a flexible and bendable material.

The substrate of the induction sheet 11 is made of a flexible and bendable material, which may be polyimide (PI), polyethylene terephthalate (PET) or thermoplastic polyurethane (TPU), etc. In order to ensure that the induction sheet 11 can be bent or flattened when stressed, the induction sheet 11 can fit various curved surfaces when used, while maintaining stable electrical properties and mechanical strength.

A conductor is formed by depositing or printing a conductive material on the substrate. Commonly used materials include copper, silver nanowires, carbon nanotubes, or conductive polymers (e.g., PEDOT:PSS). These materials are highly conductive and flexible, making them applicable to flexible electronic devices. The conductor may be manufactured by means of screen printing, inkjet printing, or chemical vapor deposition. A pattern design of the conductor may be customized (e.g., grids or strips) according to application needs, to optimize the sensitivity of touch induction.

The touch induction electrode 111 is also arranged on the substrate and directly connected to the conductor to form a complete touch induction circuit. A capacitive electrode or a pressure electrode is adopted as the touch induction electrode 111, but the capacitive electrode or the pressure electrode has different working principles. Specifically, in practical use, the capacitive electrode only needs to be designed into electrodes of different shapes and sizes at the end of a circuit of the induction sheet 11, which are used to transmit and receive the changes in the detected capacitive electric field to measure touch signals. However, the pressure electrode measures a touch signal by deforming a strain induction device to cause its own resistance to change when a pressure is applied to an electrode position.

The touch induction electrode 111 may be made of the same material as a conductor layer, or a different material, so as to optimize the contact resistance and signal transmission efficiency. The layout of the touch induction electrodes 111 adopts an array arrangement, such as a matrix arrangement.

The connection between the conductor and the touch induction electrode 111 may be achieved by direct printing, conductive adhesive bonding, or co-deposition technologies to ensure the reliability and stability of the electrical connection.

In one embodiment, FPCB is adopted as the substrate, copper is used as the conductor, and the touch induction electrodes 111 are located at the ends of circuits of different shapes and sizes.

In one embodiment, TPU and PET are adopted as the substrate, conductive silver paste is used as the conductor, and the touch induction electrodes 111 are located at the ends of circuits of different shapes and sizes.

In one embodiment, a fabric is adopted as the substrate, a flexible wire is arranged in the fabric or conductive silver paste is printed directly on the fabric, and a capacitive electrode or a pressure electrode may be adopted as the touch induction electrode 111.

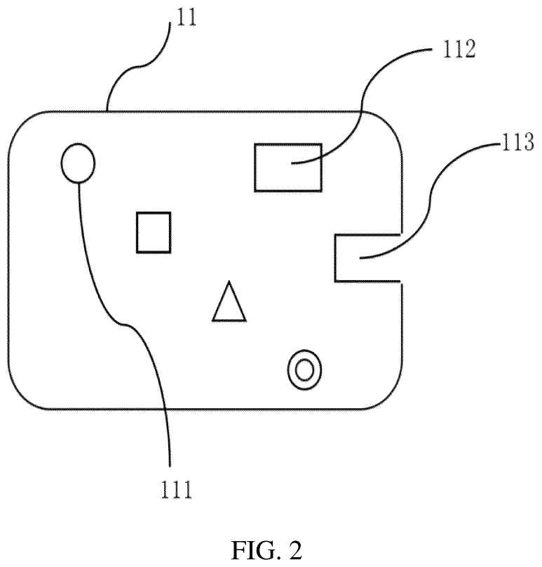

As shown in FIG. 2, the induction sheet 11 is provided with a plurality of holes 112 and/or openings 113.

The holes 112 and the openings 113 on the induction sheet 11 may be designed as circular, oval, rectangular or other geometric shapes. The sizes and distribution of the holes 112 can be adjusted according to specific requirements.

By providing the holes 112 and/or openings 113 on the induction sheet 11, the induction sheet can be conveniently positioned or cooperated with other structural parts, so as to improve the accuracy of installation.

It should be noted that if the holes 112 and/or the openings 113 are located on the touch induction electrode 111, and the capacitive electrodes are adopted as the touch induction electrodes 111, the shape or area of the touch induction electrode 111 can be changed for signal adjustment.

An embodiment of the disclosure further provides a bionic structure. The bionic structure includes a bionic body 2 and the above-mentioned tactile component 1. The touched object is the bionic body 2. The tactile component 1 is arranged on the bionic body 2. The bionic body 2 includes a profiling skeleton 22 and a covering layer 21. The covering layer 21 is arranged on the surface of the profiling skeleton 22. The induction sheet 11 is arranged between the profiling skeleton 22 and the covering layer 21.

The bionic body 2 may be in a human-like shape, an animal-like shape or an organ-like shape. The bionic body 2 in the animal-like shape may be presented as a dog, a cat, a fox or other forms, while the bionic body 2 in the organ-like shape can simulate mouth, nose or other features. It should be noted that the bionic body 2 in the organ-like shape can either exist independently or be combined with the bionic body 2 in the human-like or animal-like shape as part of the bionic body 2 in the human-like or animal-like shape.

The covering layer 21 may be one or more layers of material as an appearance structure of the profiling skeleton 22, and may be made of an elastic or hard material, such as a silicone material, fur or leather. The color, texture and thickness of the covering layer 21 can be adjusted according to needs to achieve an optimal bionic effect. The covering layer 21 and the profiling skeleton 22 may be fixed by means of adhesive bonding, mechanical fixing, hot melt or a zipper, etc.

The induction sheet 11 may be installed on the inner side of the covering layer 21 or on the surface of the profiling skeleton 22. Specifically, the induction sheet 11 may be directly installed on the inner side of the covering layer 21 or be installed in contact with the surface of the profiling skeleton 22, or some structures are designed at the installation position for auxiliary installation or positioning. For example, protrusion structures are designed on the inner side surface of the covering layer 21 or the surface of the profiling skeleton 22. The protrusion structures correspond to the openings 113 or the holes 112 on the induction sheet 11. In addition, the induction sheet 11 may be fixed on the inner side of the covering layer 21 or the surface of the profiling skeleton 22 by means of glue bonding, suturing or compression.

The induction sheet 11 is arranged between the profiling skeleton 22 and the covering layer 21, so that the induction sheet 11 can be avoided from being directly exposed on the outer surface of the covering layer 21, thereby promoting the appearance simulation of the bionic body 2. An induction plate 14 integrated with the sensor 12 and the controller 13 may be fixed on the profiling skeleton 22 by means of screws or clamping, and located on the inner side of the covering layer 21. Such design can also avoid the induction sheet 14 from being directly exposed on the outer surface of the covering layer 21, thereby further promoting the appearance simulation of the bionic body 2.

In one embodiment, the bionic body 2 is respectively provided with the tactile component 1 at different parts. The tactile structure further includes a master controller 3. The tactile components 1 corresponding to different parts of the bionic body 2 are electrically connected to the same master controller 3.

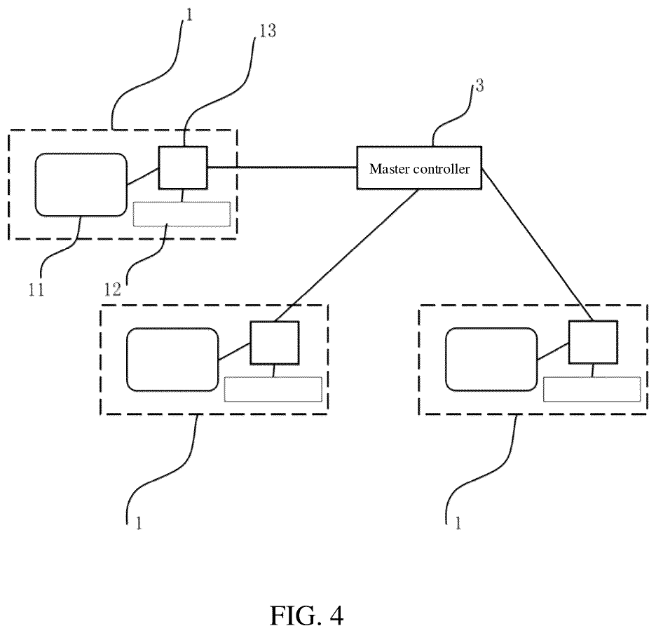

As shown in FIG. 4, two or more tactile components 1 are connected to the same master controller 3. The master controller 3 can comprehensively collect and analyze touch induction information, attitude information and acceleration information collected by the respective tactile components 1. The comprehensive analysis of the master controller 3 can be implemented based on the existing machine learning model, and the machine learning model is burned into a flash memory of the master controller 3 in the form of codes in a development stage. An MCU of ARM Cortex series or AVR series, or a system on a chip (SoC) may be selected as the master controller 3.

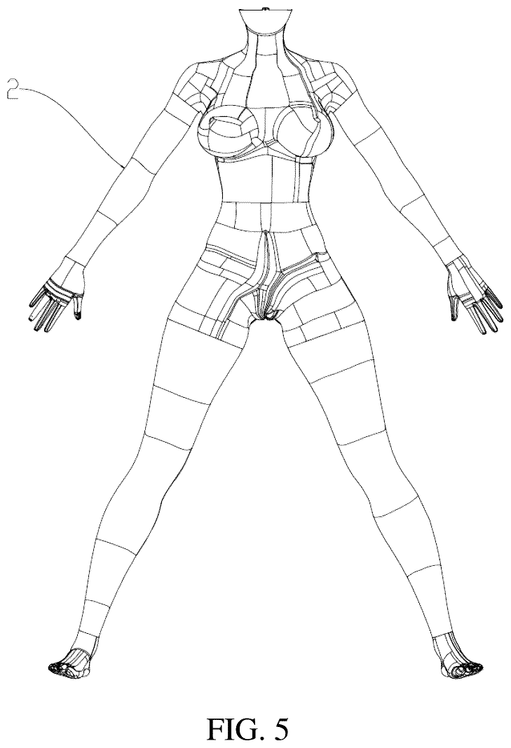

As shown in FIG. 5 to FIG. 10, in one embodiment, the bionic body 2 is a human-like form (hereinafter referred to as a human-like robot). The human-like robot is equipped with tactile components on the upper arms, lower arms, thighs, calves, abdomen, back, buttocks, chest, face and other parts. For different installation parts, the shapes and sizes of the induction sheets 11 of the tactile components will be different.

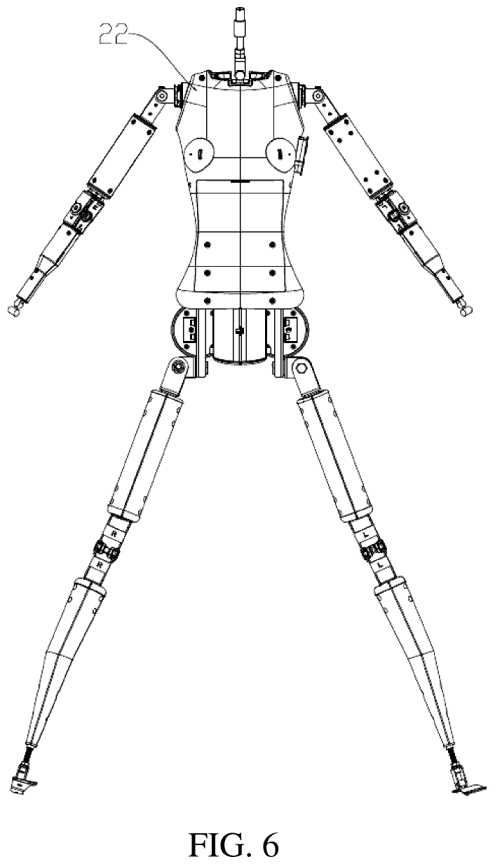

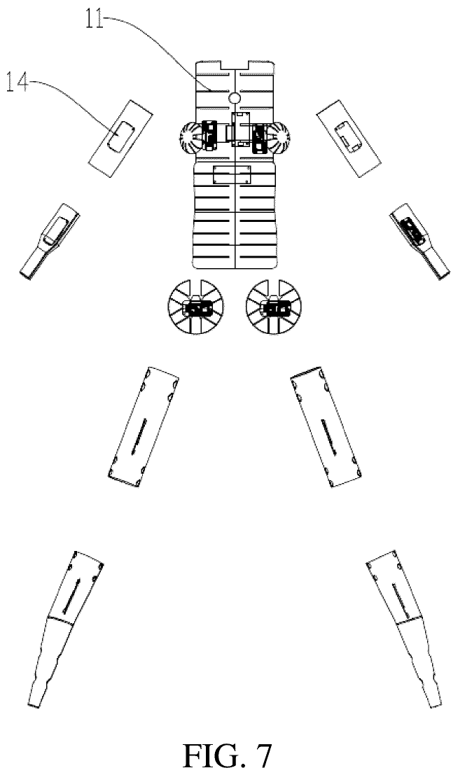

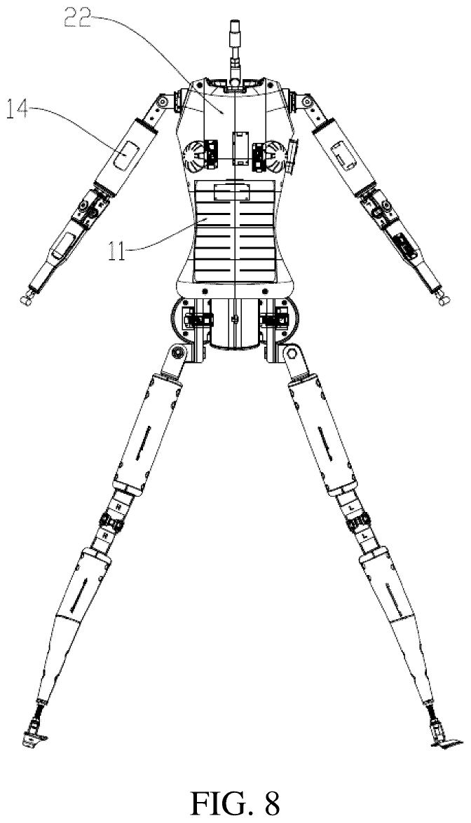

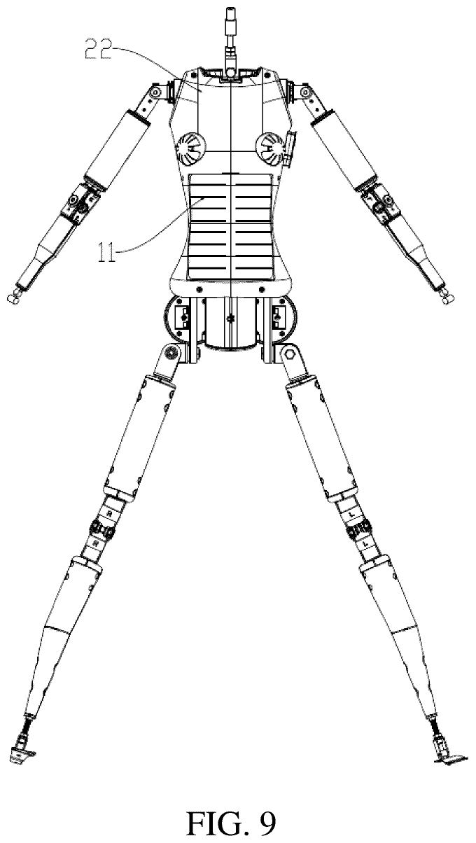

FIG. 5 illustrates an appearance of a human-like robot. Because the tactile component is installed between the covering layer and the profiling skeleton 22, the tactile component is not visible from the shape of the human-like robot, so that the appearance simulation of the human-like robot can be improved. FIG. 6 illustrates a form of a human-like robot with a covering layer being removed and only a profiling skeleton 22 remaining, and an induction component is not arranged in this state. FIG. 7 illustrates arrangement positions of a plurality of tactile components, in which a profiling skeleton 22 is not shown. As shown in FIG. 7, the shapes and sizes of the induction sheets 11 corresponding to respective parts of the profiling skeleton 22 will be different. FIG. 8 illustrates a state in which the tactile component is installed on the profiling skeleton 22. As shown in FIG. 8, some curved-surface parts of the profiling skeleton 22 may still be provided with induction sheets 11 fitting curved surfaces. FIG. 9 illustrates a state in which only the induction sheet 11 is installed on the profiling skeleton 22, and an induction plate 14 is not installed. FIG. 10 illustrates a shape of the induction sheet 11 at an abdomen position of the human-like robot.

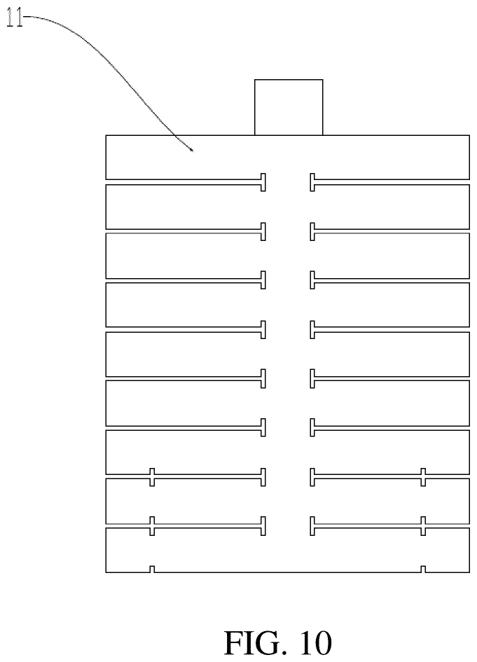

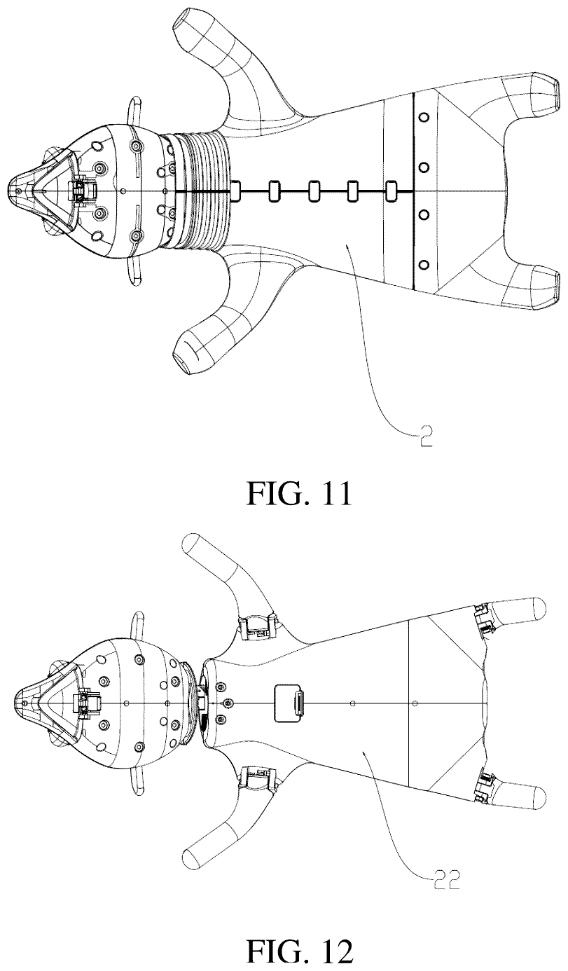

As shown in FIG. 11 to FIG. 16, in one embodiment, the bionic body 2 is a panda-like form (hereinafter referred to as a panda robot). The panda robot is equipped with tactile components on the upper arms, lower arms, thighs, calves, abdomen, head, face and other parts. For different installation parts, the shapes and sizes of the induction sheets 11 of the tactile components will be different.

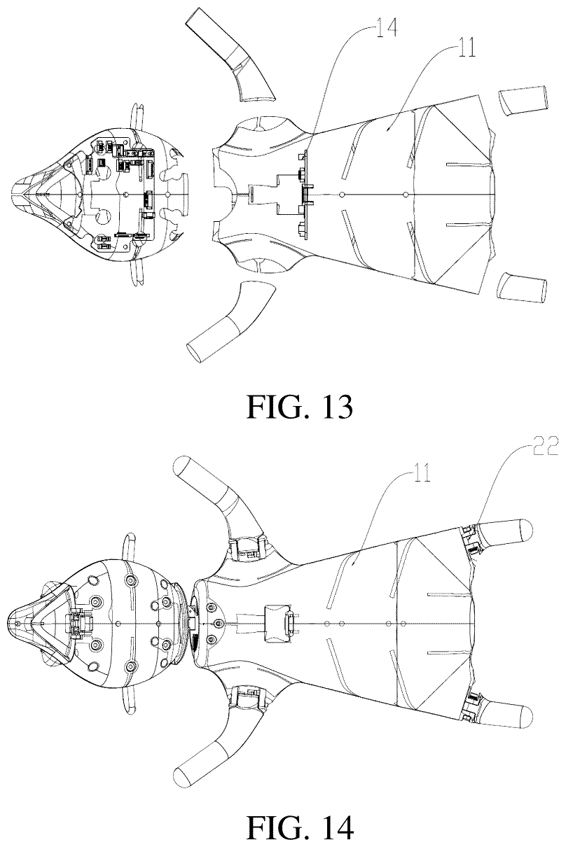

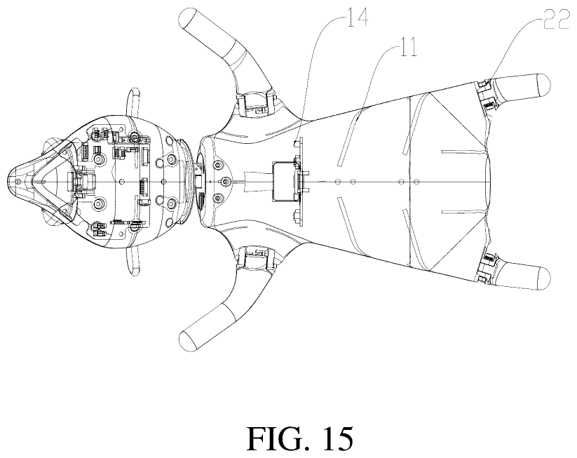

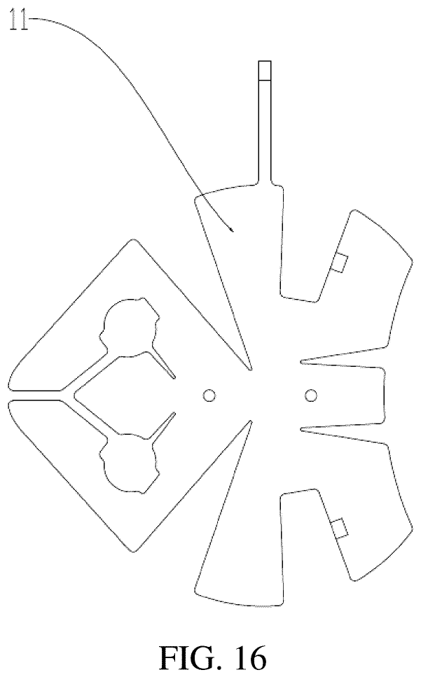

FIG. 11 illustrates an appearance of the panda robot. Because the tactile component is installed between the covering layer and the profiling skeleton 22, the tactile component is not visible from the shape of the panda robot, so that the appearance simulation of the panda robot can be improved. FIG. 12 illustrates a form of a panda robot with a covering layer being removed and only a profiling skeleton 22 remaining, and an induction component is not arranged in this state. FIG. 13 illustrates arrangement positions of a plurality of tactile components, in which a profiling skeleton 22 is not shown. As shown in FIG. 13, the shapes and sizes of the induction sheets 11 corresponding to respective parts of the profiling skeleton 22 will be different. FIG. 14 illustrates a state in which only the induction sheet 11 is installed on the profiling skeleton 22, and an induction plate 14 is not installed. FIG. 15 illustrates a state in which the tactile component is installed on the profiling skeleton 22. As shown in FIG. 15, some curved-surface parts of the profiling skeleton 22 may still be provided with induction sheets 11 fitting curved surfaces. FIG. 16 illustrates a shape of the induction sheet 11 at a head-top position of the panda robot.

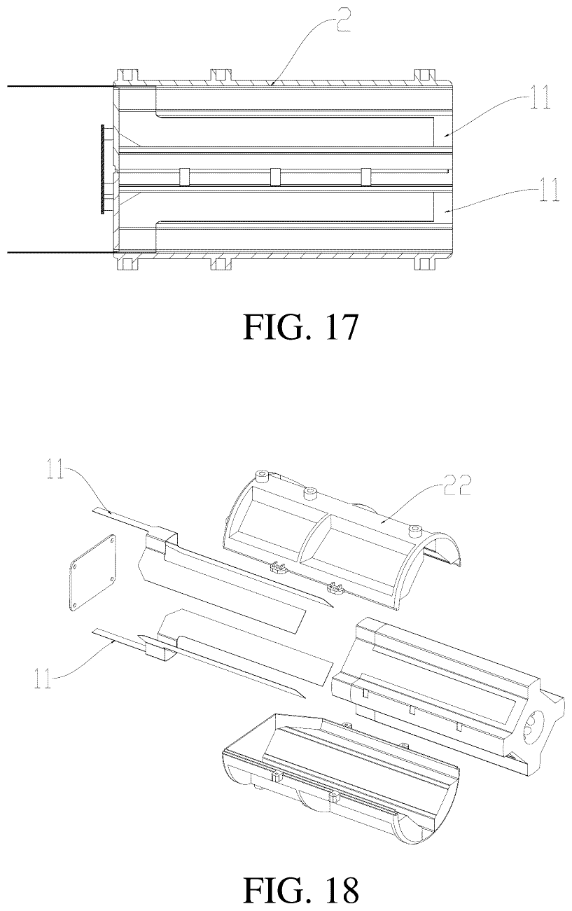

As shown in FIG. 17 and FIG. 18, in one embodiment, the bionic body 2 is in an organ form. This organ form has a channel, which may be a simulated oral cavity or nostrils of a person. Fingers, etc. of the person may enter this channel. Because there are induction sheets 11 distributed along a length direction of the channel, when the fingers and other parts of the person enter this channel and move, specific position, stay time, force and other data of the fingers and other parts of the person can be collected, and the data such as a movement velocity can be indirectly calculated.

In one embodiment, the master controller 3 is integrated with a wireless communication module. The wireless communication module may be Wi-Fi, Bluetooth, Zigbee, LoRa or other modules suitable for short-distance or medium-distance wireless transmission. The master controller 3 is wirelessly connected to a VR device or an electronic device with a VR function (such as a smart phone, a tablet computer, or a VR head mounted display) through the wireless communication module. An initial position posture of a virtual target object in a VR animation is set to be consistent with an attitude of the bionic body 2. The information acquired from the master controller 3 (this information includes touch induction information, attitude information, acceleration information and speech information, etc.) may be sent to the VR device or the electronic device with the VR function. The virtual target object in the VR animation will be presented virtually in the same form as the bionic body 2. For example, when arms of the human-like robot are raised, the virtual target object in the VR animation also presents this attitude, thereby ensuring the user's immersion in a VR environment.

It is worth noting that the information interaction between the VR device and the bionic body 2 can be regarded as a two-way information flow process. The VR device is not only a passive data receiving terminal, but also can generate a large amount of useful information. For example, the VR device may capture user's interactions (e.g., gestures and head movements) in the virtual world, user perspective data, and environmental perception information (e.g., spatial positioning and boundary awareness) of the device. These pieces of information may be combined with the touch induction information, attitude information, acceleration information, and speech interaction information from the bionic body 2. The combined information is sent to the VR device again to synchronize actions of the virtual target object with user's physical interactions.

It should be noted that if a plurality of bionic bodies 2 need to be synchronized into the same VR device, data aggregation and distribution can be carried out through a network protocol (e.g., MQTT or WebSocket) on the master controller 3, so as to realize collaborative actions of a plurality of virtual characters in the same VR environment.

In addition to VR applications, it can also be extended to an AR scene. That is, the attitude information of the bionic body 2 is mapped to the AR device, so that the user can see interactions between the virtual objects superimposed on a real scene and the bionic body 2 through AR glasses or mobile phones.

An embodiment of the disclosure further provides a perceptual feedback method of a bionic structure. This method is applicable to the above-mentioned bionic structure. This method specifically includes the following steps: S10A-S30A.

At S10A, touch induction information, attitude information and acceleration information collected by tactile components at respective parts of a touched object are acquired when a touch object is in contact with the touched object.

In the present embodiment, the touch object is a person, and the touched object is a human-like robot.

The tactile components at the respective parts of the human-like robot are connected to the same master controller. The master controller can receive the touch induction information, attitude information and acceleration information collected by the tactile components at the respective parts.

At S20A, the touch induction information, attitude information and acceleration information collected by the tactile components at the respective parts are compressively analyzed to obtain emotional information of the touch object.

Because the comprehensive analysis of the master controller can be implemented based on the existing machine learning model, specifically, the touch induction information, attitude information and acceleration information are collected from each tactile component, these data are normalized, and the data of different dimensions are adjusted to a unified scale. The noise is eliminated by a filter to improve the quality of the data. A deep neural network (DNN) or convolutional neural network (CNN) may be selected to divide the normalized data into a training set, a validation set, and a test set. Trained through a feedforward neural network, the model is able to learn a relationship between tactile data and an expected output. A backpropagation algorithm and an optimizer (e.g., Adam or SGD) are used to update model parameters. A loss function is monitored to ensure that the model gradually converges. Hyperparameter tuning: network structures (e.g., number of layers and number of neurons) and training parameters (e.g., learning rate and batch size) are adjusted to optimize model performances. The trained model is burnt into the master controller. After burning, the master controller can analyze the data transmitted by the respective tactile components in real time to analyze emotional information of the person, such as friendly, vicious, naughty, happy, angry, sad, etc.

At S30A, feedback information is generated by the touched object according to the emotional information of the touch object, the feedback information including sounds, action behaviors, and facial expressions.

In this embodiment, appropriate sounds, which may be speech, music, or other sound effects, are played through a remote output apparatus owned by or remotely connected to the human-like robot. The content of the sounds is related to emotional information, for example, to express cheerful speech or comforting music. Body movements, such as waving, nodding and hugging, are implemented through a control driver of the human-like robot, and are thus consistent with an emotional state. For example, a person holds upper arms on both sides of the human-like robot and laughs at the human-like robot, and then the robot will determine that this person may be happy and want to share the emotional state with the robot. The human-like robot can make movements such as opening its arms while recognizing that the person is happy. The human-like robot has the ability to animate its face, and change its facial expressions through a servo motor or flexible material to reflect emotional information. For example, the face may show a concern expression while recognizing that the touch object shows concern.

It should be noted that the action behaviors of the above-mentioned human-like robot and the facial expressions can be realized through mechanical actions, and the mechanical structure design of the human-like robot may refer to the Chinese patents with patent publication numbers of CN117124343A and CN117138362A.

An embodiment of the disclosure further provides a perceptual feedback method of a bionic structure. This method is applicable to the above-mentioned bionic structure. This method specifically includes the following steps: S10B-S30B.

At S10B, touch induction information, attitude information and acceleration information collected by the tactile components at the respective parts of the touched object are acquired when a touch object is in contact with the touched object, and speech or text interaction information between the touch object and the touched object are acquired.

In the present embodiment, the touch object is a person, and the touched object is a human-like robot.

The tactile components at the respective parts of the human-like robot are connected to the same master controller 3. The master controller 3 can receive the touch induction information, attitude information and acceleration information collected by the tactile components at the respective parts, as well as speech or text interaction information between the person and the human-like robot.

It should be noted that if the person interacts with the human-like robot in language, a speech-to-text module of the human-like robot may be used to convert the content spoken by the person into a text form, and then carry out subsequent processing to reduce the difficulty of processing. Of course, the speech-to-text module may be integrated into the master controller or as a stand-alone module.

At S20B, the touch induction information, attitude information and acceleration information collected by the tactile components at the respective parts are comprehensively analyzed to obtain emotional information of the touch object.

Because the comprehensive analysis of the master controller can be implemented based on the existing machine learning model, specifically, the touch induction information, attitude information and acceleration information are collected from each tactile component, these data are normalized, and the data of different dimensions are adjusted to a unified scale. The noise is eliminated by a filter to improve the quality of the data. A deep neural network (DNN) or convolutional neural network (CNN) may be selected to divide the normalized data into a training set, a validation set, and a test set. Trained through a feedforward neural network, the model is able to learn a relationship between tactile data and an expected output. A backpropagation algorithm and an optimizer (e.g., Adam or SGD) are used to update model parameters. A loss function is monitored to ensure that the model gradually converges. Hyperparameter tuning: network structures (e.g., number of layers and number of neurons) and training parameters (e.g., learning rate and batch size) are adjusted to optimize model performances. The trained model is burnt into the master controller. After burning, the master controller can analyze the data transmitted by the respective tactile components in real time to analyze emotional information of the person, such as friendly, vicious, naughty, happy, angry, sad, etc. An algorithm for an emotion analysis part based on the speech or text interaction information may refer to the Chinese patent with patent publication number CN118916466A.

At S30B, feedback information is generated by the touched object according to the emotional information of the touch object, the feedback information including sounds, action behaviors, and facial expressions.

In this embodiment, appropriate sounds, which may be speech, music, or other sound effects, are played through a remote output apparatus owned by or remotely connected to the human-like robot. The content of the sounds is related to emotional information, for example, to express cheerful speech or comforting music. Body movements, such as waving, nodding and hugging, are implemented through a control driver of the human-like robot, and are thus consistent with an emotional state. For example, a person holds upper arms on both sides of the human-like robot and laughs at the human-like robot, and then the robot will determine that this person may be happy and want to share the emotional state with the robot. The human-like robot can make movements such as opening its arms while recognizing that the person is happy. The human-like robot has the ability to animate its face, and change its facial expressions through a servo motor or flexible material to reflect emotional information. For example, the face may show a concern expression while recognizing that the touch object shows concern.

It should be noted that the action behaviors of the above-mentioned human-like robot and the facial expressions can be realized through mechanical actions, and the mechanical structure design of the human-like robot may refer to the Chinese patents with patent publication numbers of CN117124343A and CN117138362A.

The above are only specific embodiments of the disclosure, but the protection scope of the disclosure is not limited thereto. Within the technical scope disclosed in the disclosure, any changes or replacements easily derived by a person skilled in the art shall fall within the protection scope of the disclosure. Therefore, the protection scope of the disclosure should be subject to the protection scope of the claims.

1. A tactile component, comprising:
an induction sheet, which is arranged on a touched object and used to collect a touch induction signal while being in direct or indirect contact with a touch object;
a sensor, which is arranged on the touched object and used to collect an attitude signal of the touched object and an acceleration signal of the touch object during the direct or indirect contact of the induction sheet with the touch object; and
a controller, which is connected to the induction sheet and the sensor and used to generate touch induction information, attitude information and acceleration information according to the received touch induction signal, attitude signal and acceleration signal, wherein
the induction sheet can be bent or flattened when stressed.

2. The tactile component according to claim 1, wherein the induction sheet is provided with at least one touch induction electrode which is used to generate the touch induction signal while being in direct or indirect contact with the touch object.

3. The tactile component according to claim 2, wherein the induction sheet comprises a substrate and a conductor; the conductor and the touch induction electrode are both arranged on the substrate; the conductor is connected to the touch induction electrode; and the substrate is made of a flexible and bendable material.

4. The tactile component according to claim 3, wherein the touch induction electrode is a capacitive electrode or a pressure electrode.

5. The tactile component according to claim 1, wherein the induction sheet is provided with a plurality of holes and/or openings.

6. A bionic structure, comprising a bionic body and at least one tactile component according to claim 1, wherein the touched object is the bionic body; the tactile component is arranged on the bionic body; the bionic body comprises a profiling skeleton and a covering layer; the covering layer is arranged on the surface of the profiling skeleton; and the induction sheet is arranged between the profiling skeleton and the covering layer.

7. The bionic structure according to claim 6, wherein the bionic body is in a human-like shape, an animal-like shape or an organ-like shape.

8. The bionic structure according to claim 6, wherein the bionic body is respectively provided with the tactile component at different parts and further comprises a master controller; and the tactile components corresponding to different parts of the bionic body are electrically connected to the same master controller.

9. The bionic structure according to claim 6, wherein the induction sheet is provided with at least one touch induction electrode which is used to generate the touch induction signal while being in direct or indirect contact with the touch object.

10. The bionic structure according to claim 9, wherein the induction sheet comprises a substrate and a conductor; the conductor and the touch induction electrode are both arranged on the substrate; the conductor is connected to the touch induction electrode; and the substrate is made of a flexible and bendable material.

11. The bionic structure according to claim 10, wherein the touch induction electrode is a capacitive electrode or a pressure electrode.

12. The bionic structure according to claim 6, wherein the induction sheet is provided with a plurality of holes and/or openings.

13. A perceptual feedback method of a bionic structure, comprising:
acquiring touch induction information, attitude information and acceleration information collected by tactile components at respective parts of a touched object when a touch object is in contact with the touched object;
performing comprehensive analysis on the touch induction information, attitude information, acceleration information and interaction information collected by the tactile components at the respective parts to obtain emotional information of the touch object; and
generating feedback information by the touched object according to the emotional information of the touch object, the feedback information comprising sounds, action behaviors, and facial expressions.

14. A perceptual feedback method of a bionic structure, comprising:
acquiring touch induction information, attitude information and acceleration information collected by tactile components at respective parts of a touched object when a touch object is in contact with the touched object, and acquiring speech or text interaction information between the touch object and the touched object;
performing comprehensive analysis on the touch induction information, attitude information, acceleration information and interaction information collected by the tactile components at the respective parts to obtain emotional information of the touch object; and
generating feedback information by the touched object according to the emotional information of the touch object, the feedback information comprising sounds, action behaviors, and facial expressions.
